(19) United States
(12) Patent Application Publication
(10) Pub. No.: US 2007/0174450 A1
(43) Pub. Date: Jul. 26, 2007

(54) SYSTEM AND METHOD FOR DISTRIBUTING AND MONITORING EMAILS

(75) Inventors: Chung-I Lee, Tu-Cheng (TW); Hai-Hong Lin, Shenzhen (CN); De-Yi Xie, Shenzhen (CN); Wen-Feng Zhang, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: HON HAI PRECISION INDUSTRY CO., LTD., Tu-Cheng (TW)

(21) Appl. No.: 11/558,469

(22) Filed: Nov. 10, 2006

(30) Foreign Application Priority Data
Jan. 20, 2006 (TW) 95102380

(51) Int. Cl. G06F 15/173

(52) U.S. Cl. 709/224

(57) ABSTRACT

A method for distributing and monitoring emails is provided. The method includes the steps of: obtaining computer system time; and performing one or more of the following services according to the computer system time: performing email collecting service; performing error checking service; performing monitoring service; and performing email distributing service. A related system is also disclosed.

### BACKGROUND OF THE INVENTION

1. Field of the Invention

The invention is related to emails management, especially to a system and a method for distributing and monitoring emails.

2. General Background

A user of a computer system that is connected to other computer systems via one or more networks, for example an Intranet or the Internet, may electronically distribute and receive emails to/from the other computer systems. This provides a means of communicating with users of the other computer systems.

To distribute and receive emails, a computer that forms part of a network uses an information transfer application, for example Lotus Notes, which provides the computer user with the ability to create and distribute emails, and to access emails received from the other computer systems.

The Lotus Notes is an information transfer application to provide email service. The Lotus Notes also has capabilities of calendar and scheduling, integrated instant messaging, personal information management (PIM) tools, discussion forums, team rooms, and reference data with basic workflow, along with a powerful desktop platform for collaborative applications.

However, in an enterprise, with a large quantity of emails distributed/received, the Lotus Notes and other information transfer applications may distribute/receive emails repeatedly or unsuccessfully. The user may receive the emails again and again, or may not receive the emails at all, thus decreasing the work efficiency.

What is needed, therefore, is a system and method for distributing and monitoring emails that can controls emails distributing according to time requirements, detect the emails flows, monitor system statuses, and check errors of emails distributing, thus enhancing timeliness of the emails distributing, ensuring communication of the information with the users, and improving efficiency.

### SUMMARY OF THE INVENTION

A system for distributing and monitoring emails in accordance with a preferred embodiment is provided. The system includes an application server and a database. The application server includes: a time getting module configured for obtaining computer system time; a judging module configured for computing whether it is time to perform one or more services according to the computer system time; and a service performing module configured for performing the one or more system services.

Another preferred embodiment provides a computer-based method for distributing and monitoring emails. The method includes the steps of: obtaining computer system time; and performing one or more of the following services according to the computer system time: performing email collecting service; performing error checking service; performing monitoring service; and performing email distributing service.

Other advantages and novel features of the present invention will be drawn from the following detailed description of a preferred embodiment and preferred method with the attached drawings.

### BRIEF DESCRIPTION OF THE DRAWINGS

FIG. 1 is a schematic diagram of hardware infrastructure of a system for distributing and monitoring emails in accordance with a preferred embodiment;

FIG. 2 is a schematic diagram of function modules of an application server in FIG. 1;

FIG. 3 is a schematic diagram illustrating a table in which the statues of the emails distributing are recorded;

FIG. 4 is a flowchart of a method for distributing and monitoring emails in accordance with a preferred embodiment;

FIG. 5 is a flowchart illustrating an email collecting service in detail;

FIG. 6 is a flowchart illustrating an email error checking service in detail; and

FIG. 7 is a flowchart illustrating an email distributing service in detail.

### DETAILED DESCRIPTION OF THE INVENTION

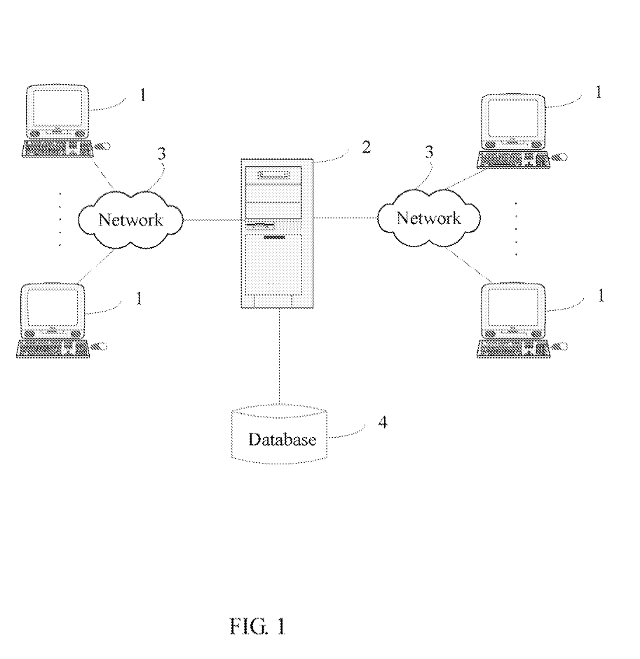

FIG. 1 is a schematic diagram of hardware infrastructure of a system for distributing and monitoring emails (hereinafter “the system”), in accordance with a preferred embodiment. The system typically includes a plurality of distributed client computers 1 (only four shown), an application server 2, a network 3, and a database 4. The application server 2 is connected to the client computers 1 via the network 3, and further is connected to the database 4.

Each client computer 1 provides a user interface, through which users can access the application server 2 to input and output data. The application server 2 includes many function modules, which are mainly configured for collecting and distributing emails between the client computers 1 via the network 3. The network 3 may be an Intranet or the Internet.

Furthermore, the system still may include a plurality of databases that connects with the client computers 1 and the application server 2 (not shown in FIG. 1). Emails sent by the client computers 1 may be temporarily stored in the one of the plurality of databases, while waiting for the application server 2 to collect emails according to the scheduling of collecting the emails.

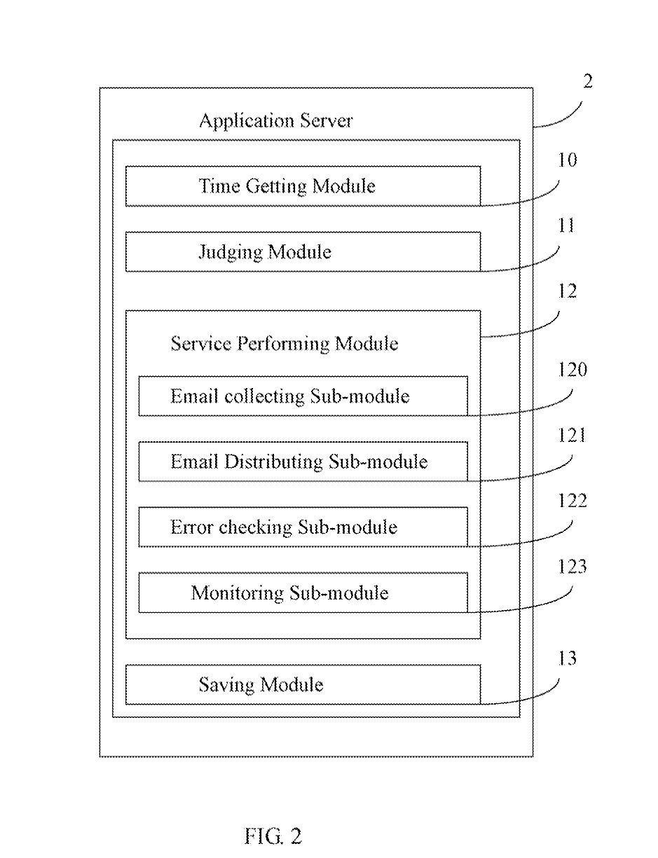

FIG. 2 is a schematic diagram of function modules of the application server 2. The application server 2 includes a time getting module 10, a judging module 11, a service performing module 12, and a saving module 13.

The time getting module 10 is configured for obtaining computer system time. The judging module 11 is configured for determining whether it is time to perform one or more services according to the computer system time. The services may include email collecting service, error checking service, status monitoring service, and email distributing service.

The judging module 11 is further configured for determining a scheduling of collecting/distributing emails. The scheduling may be collecting/distributing emails instantly (in real-time), regularly, and/or daily. An instant scheduling means that the emails are collected or distributed in real-time, i.e. the emails are collected by the application server 2 the instant the emails are sent by any client computer 1 or distributed by the application server 2 the instant the emails are collected by the application server 2; a regular scheduling means that the emails are collected and/or distributed at every fixed time interval; and a daily scheduling means that the emails are collected and/or distributed once a day at a fixed time, for example, at 8 A.M. everyday.

The service performing module 12 is configured for performing the one or more system service, and includes an email collecting sub-module 120, an email distributing sub-module 121, an error checking sub-module 122, and a status monitoring sub-module 123.

The email collecting sub-module 120 is configured for collecting emails according to the scheduling of collecting the emails. The email distributing sub-module 121 is configured for distributing emails according to the scheduling of distributing the emails.

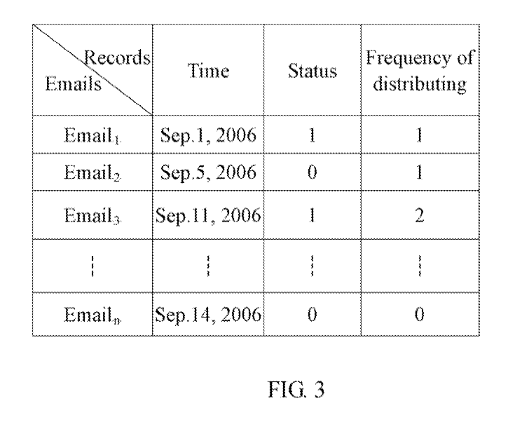

The error checking sub-module 122 is configured for checking and processing errors while distributing the emails. For example, in the preferred embodiment, the distributing statuses of the emails are recorded in a table in the database 4. The table refers to FIG. 3, in which, time, status (successfully or unsuccessfully), and frequency of distributing the emails have been recorded. Herein, in the status column, a value “1” means the email was distributed successfully. Similarly, a value “0” means the email was distributed unsuccessfully.

In the preferred embodiment, if an email was distributed successfully by the email distributing sub-module 121, the status of the email is recorded in the table correspondingly with a “1”. However, the email may be rejected by a designated client computer 1, the email is not received, thus distributed unsuccessfully and returns to the database. The email checking sub-module 122 updates the status of the email with a “0”.

The status monitoring sub-module 123 is configured for monitoring statuses of the system, and distributing a result of the monitoring statuses to a system administrator. For example, if the judging module 11 detects that the scheduling of distributing an email or the scheduling of receiving an email is neither instant, nor regular, nor daily, the status monitoring sub-module 123 sends a status email notifying the administrator of the statuses.

The saving module 13 is configured for recording each operation of collecting email, distributing email, checking error, and so on in the database 4.

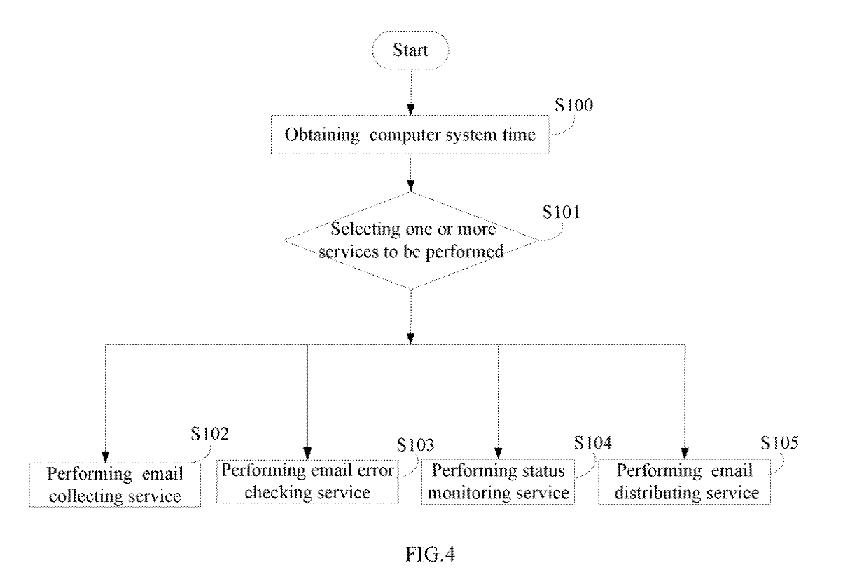

FIG. 4 is a flowchart of a method for distributing and monitoring emails in accordance with a preferred embodiment. In step S100, the time getting module 10 obtains computer system time. In step S101, the judging module 11 determines the services to be performed according to the computer system time. The services may include: performing the email collecting service (step S102), performing the email error checking service (step S103), performing the status monitoring service (step S104), and performing the email distributing service (step S105).

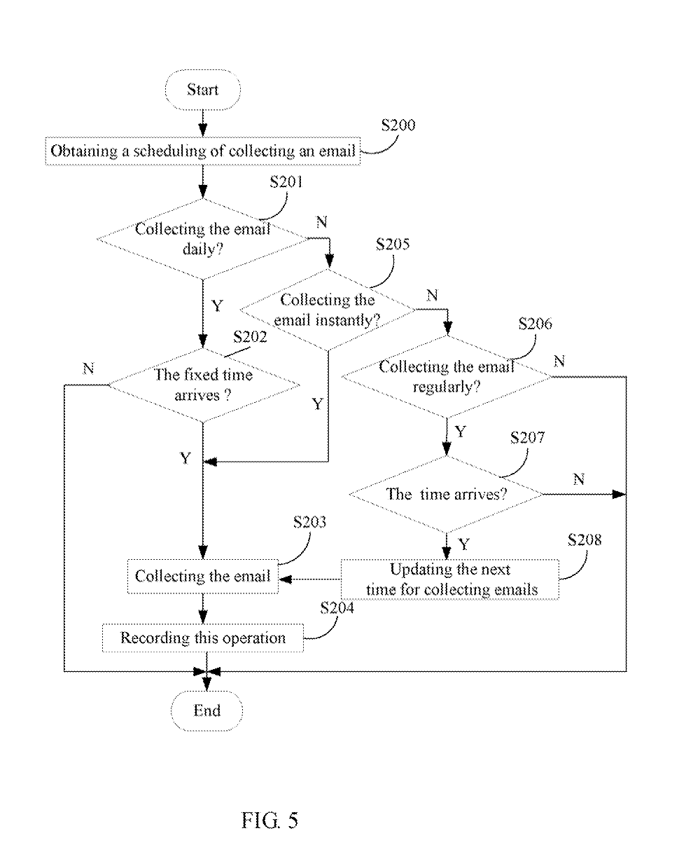

FIG. 5 is a flowchart illustrating step S102, namely performing the email collecting service in detail. In step S200, the email collecting sub-module 120 obtains the scheduling of collecting an email. In step S201, the judging module 11 determines whether the scheduling of collecting the email is daily. If the scheduling is daily, in step S202, the judging module 11 determines whether the fixed time for collecting the email arrives, namely whether the system time equals to the fixed time for collecting emails daily. If the system time equals to the fixed time, in step S203, the email collecting sub-module 120 collects the email. In step S204, the saving module 13 records this operation in the database 4.

If, in step S201, the judging module 11 determines the scheduling of collecting the email is not daily, in step S205, the judging module 11 further determines whether the scheduling of collecting the email is instant. If the scheduling is instant, the procedure returns to step S203 described above directly.

If, in step S205, the judging module 11 determines the scheduling of collecting the email is not instant, in step S206, the judging module 11 further determines whether the scheduling of collecting the email is regular. If the scheduling of collecting the email is not regular, the procedure ends directly.

Otherwise, in step S207, the judging module determines whether the time for collecting the email arrives, namely whether a time difference between the system time and a previous time the application server collected emails equals to the fixed time interval. If the time difference equals to the fixed time interval, in step S208, the time getting module 10 updates the next time for collecting emails according to the fixed time interval, and then the procedure turns to step S203 described above.

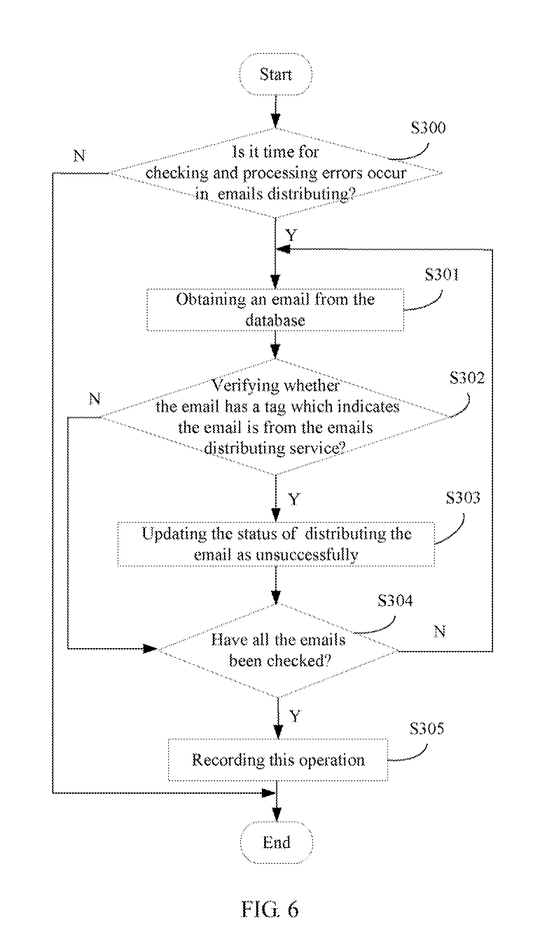

FIG. 6 is a flowchart illustrating step S103, namely performing the email error checking service in detail. In step S300, the judging module 11 determines whether it is time for checking and processing errors occur in emails distributing. If it is not time for checking and processing errors, the procedure ends. Otherwise, in step S301, the errors checking sub-module 122 obtains an email from the database 4.

In step S302, the judging module 11 determines whether the email has a tag that indicates the email is from the email distributing service of the present system. If the email does not have the tag, this indicates that the email comes from other email transfer systems, the procedure goes directly to step S304 described below.

Otherwise, if the email has the tag and the status of the email is a “1”, in step S303, the errors checking sub-module 122 updates the status of the email to a “0” in the table corresponding in the database 4.

In step S304, the judging module 11 determines whether all the emails have been checked. If any email has not been checked, the procedure returns to step S301 described above, and the errors checking sub-module 122 obtains another email from the database 4.

Otherwise, if all the emails have been checked, in step S305, the saving module 13 records this operation.

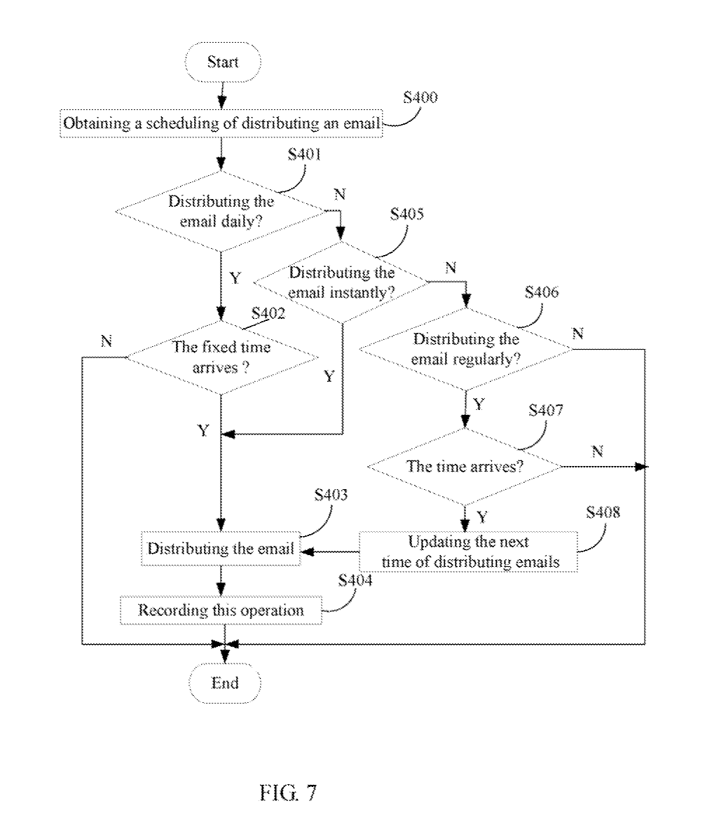

FIG. 7 is a flowchart illustrating step S105, namely performing the email distributing service in detail. In step S400, the email distributing sub-module 121 obtains the scheduling of distributing an email. In step S401, the judging module 11 determines whether the scheduling of distributing the email is daily. If the scheduling is daily, in step S402, the judging module 11 whether the fixed time for distributing the email arrives, namely whether the system time equals to the fixed time for distributing emails daily. If the system time equals to the fixed time, in step S403, the email distributing sub-module 121 distributes the email. In step S404, the saving module 13 records this operation in the database 4.

If, in step S401, the judging module 11 determines the scheduling of distributing the email is not daily, in step S405, the judging module 11 further determines whether the scheduling of distributing the email is instant. If the scheduling is instant, the procedure turns to step S403 described above directly.

If, in step S405, the judging module 11 determines the scheduling of distributing the email is not instant, in step S406, the judging module 11 further determines whether the scheduling of distributing the email is regular. If the scheduling of distributing the email is not regular, the procedure ends directly.

Otherwise, in step S407, the judging module determines whether the time for distributing the email arrives, namely whether a time difference between the system time and a previous time the application server distributed emails equals to the fixed time interval. If the time difference equals to the fixed time interval, in step S408, the time getting module 10 updates the next time for distributing emails according to the fixed time interval, and then the procedure turns to step S403 described above.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

What is claimed is:

1. A system for distributing and monitoring emails comprising an application server, the application server comprising:
a time getting module configured for obtaining computer system time;
a judging module configured for determining whether it is time to perform one or more services according to the computer system time; and
a service performing module configured for performing the one or more system services.

2. The system according to claim 1, wherein the service performing module comprises:
an email collecting sub-module configured for collecting emails to be distributed;
an error checking sub-module configured for checking and processing errors in emails distributing;
a status monitoring sub-module configured for monitoring status of the system; and
an emails distributing sub-module configured for distributing the emails.

3. The system according to claim 1, wherein the judging module is further configured for determining a scheduling of collecting/distributing emails.

4. The system according to claim 3, wherein the scheduling of collecting/distributing emails is one of: collecting/distributing emails daily, collecting/distributing emails instantly, and collecting/distributing emails regularly.

5. The system according to claim 1, wherein the application server further comprises a saving module configured for recording each operation.

6. A computer-based method for distributing and monitoring emails, the method comprising the steps of:
obtaining computer system time; and
performing one or more of the following services according to the computer system time:
performing email collecting service;
performing error checking service;
performing monitoring service; and
performing email distributing service.

7. The method according to claim 6, wherein the step of performing email collecting service comprises:
obtaining a scheduling of collecting an email;
collecting the email according to the scheduling when it is time for collecting the email; and
recording the operation.

8. The method according to claim 7, wherein the scheduling of collecting an email is one of:
collecting the email daily, collecting the email instantly, and collecting the email regularly.

9. The method according to claim 6, wherein the step of performing error checking service comprises:
determining whether it is time for checking and processing errors in emails distributing;
obtaining an email from a database;
determining whether the email has a tag which indicates the email is from the email distributing service;
updating the status of the email as unsuccessful if the email has the tag;
determining whether all the emails have been checked; and
recording the operation if all the emails have been checked.

10. The method according to claim 9, further comprising:
returning to the step of obtaining an email from the database, if any email has not been checked.

11. The method according to claim 6, wherein the step of performing email distributing service comprises:
obtaining a scheduling of distributing an email;
distributing the email according to the scheduling when it is time for distributing the email; and
recording the operation.

12. The method according to claim 11, wherein the scheduling of distributing an email is one of: distributing emails daily, distributing emails instantly, and distributing emails regularly.
